(19) United States
(12) Patent Application Publication
(10) Pub. No.: US 2023/0176914 A1
(43) Pub. Date: Jun. 8, 2023

(54) COMPUTER-READABLE RECORDING MEDIUM STORING CONTROL PROGRAM, CONTROL APPARATUS, AND CONTROL METHOD

(71) Applicant: Fujitsu Limited, Kawasaki-shi (JP)

(72) Inventors: Hiroyoshi KODAMA, Isehara (JP); Takahide YOSHIKAWA, Kawasaki (JP)

(73) Assignee: Fujitsu Limited, Kawasaki-shi (JP)

(21) Appl. No.: 17/823,218

(22) Filed: Aug. 30, 2022

(30) Foreign Application Priority Data
Dec. 7, 2021 (JP) 2021-198737

(51) Int. Cl. G06F 9/50; G06N 20/00

(52) U.S. Cl. CPC G06F 9/5038; G06F 9/5044; G06N 20/00

(57) ABSTRACT

A computer-readable recording medium stores a control program for causing a computer configured to execute scheduling of a job across a plurality of pieces of hardware deployed at a plurality of sites to execute a process. The process includes acquiring software information on a plurality of tasks included in the job, hardware information on the plurality of pieces of hardware, and site information on the plurality of sites, and determining which task of the job that has been input is to be allocated to which piece of hardware by using a result of machine learning based on the software information, the hardware information, and the site information that have been acquired.

### CROSS-REFERENCE TO RELATED APPLICATION

This application is based upon and claims the benefit of priority of the prior Japanese Patent Application No. 2021-198737, filed on Dec. 7, 2021, the entire contents of which are incorporated herein by reference.

### FIELD

The embodiment discussed herein is related to a computer-readable recording medium storing a control program, a control apparatus, and a control method.

### BACKGROUND

Supercomputers are installed at universities, research institutions, and the like, and contribute to academic and industrial development.

There is a system that utilizes various kinds of data in computation by using supercomputers installed at a plurality of sites. Job allocation across the sites is optimized by using software information.

International Publication Pamphlet No. WO 2012/124295 and Japanese Laid-open Patent Publication No. 2004-302748 are disclosed as related art.

### SUMMARY

According to an aspect of the embodiments, a recording medium storing a control program for causing a computer configured to execute scheduling of a job across a plurality of pieces of hardware deployed at a plurality of sites to execute a process including: acquiring software information on a plurality of tasks included in the job, hardware information on the plurality of pieces of hardware, and site information on the plurality of sites; and determining which task of the job that has been input is to be allocated to which piece of hardware by using a result of machine learning based on the software information, the hardware information, and the site information that have been acquired.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates graphs indicating a change in system use fee in the related art and in an embodiment;

FIG. 2 is a block diagram for schematically describing a job execution process in the embodiment;

FIG. 3 is a table for describing an example of software information, hardware information, and site information in the embodiment;

FIG. 4 is a block diagram schematically illustrating an example of a hardware configuration of an information processing system according to the embodiment;

FIG. 5 is a flowchart for describing an optimization architecture of a job scheduling process in the embodiment;

FIG. 6 is a table illustrating a first example of user input information in the embodiment;

FIG. 7 is a table illustrating a first example of user job analysis information in the embodiment;

FIG. 8 is a table illustrating a first example of presented job scheduling information in the embodiment;

FIG. 9 is a table illustrating a second example of the user input information in the embodiment;

FIG. 10 is a table illustrating a second example of the user job analysis information in the embodiment;

FIG. 11 is a table illustrating a second example of the presented job scheduling information in the embodiment; and

FIG. 12 is a block diagram schematically illustrating an example of a hardware configuration of a multi-site job scheduler in the embodiment.

### DESCRIPTION OF EMBODIMENTS

To use optimum hardware for simulations in various fields, hardware configurations at respective sites are expected to become “heterogeneous” environments to each other. In such heterogeneous environments, it may be difficult to optimize job allocation of across the sites only with software information.

In one aspect, an object is to provide optimum job scheduling in consideration of an environment that varies from site to site.

### [A] Embodiment

An embodiment will be described below with reference to the drawings. The embodiment described below is merely illustrative and is not intended to exclude employment of various modification examples or techniques that are not explicitly described in the embodiment. For example, the present embodiment may be implemented by variously modifying the embodiment within a range not departing from the gist of the embodiment. Each of the drawings is not intended to indicate that only the elements illustrated therein are included. Thus, other functions or the like may be included.

Since the same reference sign denotes the same or similar elements in the drawings, the description thereof is omitted below.

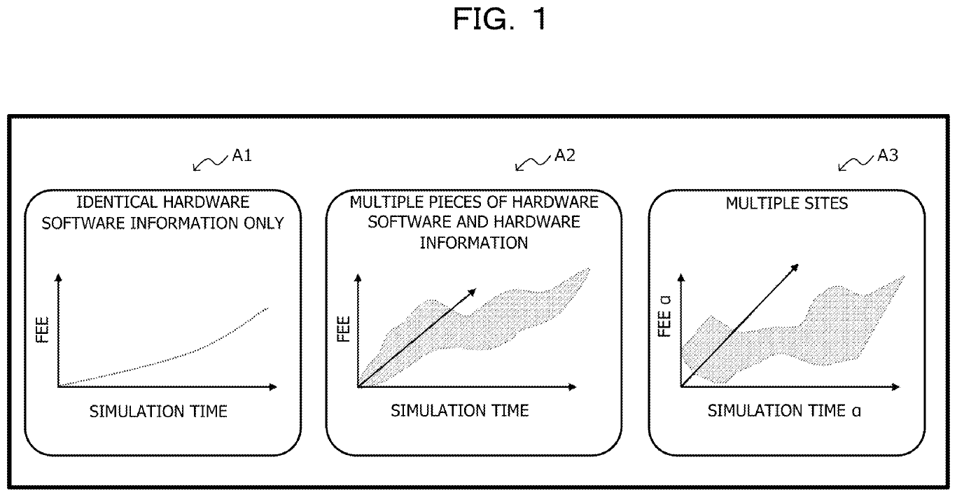

FIG. 1 illustrates graphs indicating a change in system use fee in the related art and in the embodiment.

In the related example indicated by a reference sign Al, since the efficiency of job scheduling is increased in identical pieces of hardware by using only software information, for example, the fee paid by a user to use the system is determined according to a simulation time.

For example, information such as power and a computation time used for a simulation and information such as cooling power used for the simulation are based on hardware information and site information. For example, to perform optimization across multiple sites, a user request (in other words, usability) and hardware efficiency of a service provider are to be satisfied by utilizing the hardware information and the site information (in other words, facility information) that vary from site to site.

For example, in the case of identical pieces of hardware, an axis of execution performance may be omitted. Thus, a fee system according to the simulation time may be built. However, if the pieces of hardware are different from each other, the performance is not uniform. Thus, the axis of the execution performance is added, resulting in three dimensions. Since a cooling method and a cooling device vary from site to site, the fee is to be considered by correcting the parameters hitherto used.

In an embodiment indicated by a reference sign A2, a job is decomposed into tasks, and the individual tasks are executed by various pieces of hardware. Thus, the system use fee is represented by a three-dimensional graph in which, in addition to the axis of simulation time, an axis indicating by which piece of hardware the task is executed, for example, the axis of the execution performance of hardware is added.

In an embodiment indicated by a reference sign A3, since each job is executed at a plurality of sites, a coefficient (α) for reflecting various states different from site to site is applied to the parameters of the three axes indicated by the reference sign A2. An architecture for increasing the data transfer efficiency is important when a job is executed across the sites.

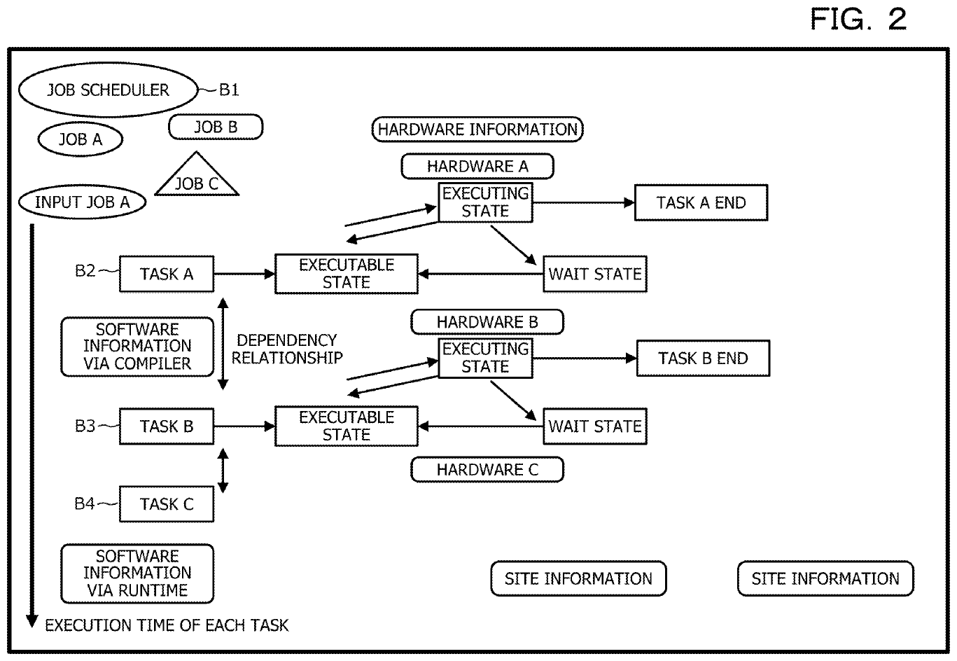

FIG. 2 is a block diagram for schematically describing a job execution process in the embodiment.

In the embodiment, a job is scheduled in consideration of software information, hardware information, and site information. At that time, each task is deployed based on a user request (in other words, usability) such that the hardware efficiency is maximized.

A job scheduler indicated by a reference sign B1 performs scheduling of a job A, a job B, and a job C. As indicated by each of reference signs B2 to B4, in response to input of the job A, the job A is decomposed into tasks A, B, and C having a dependency relationship with each other, and the tasks A, B, and C are sequentially executed.

In the example indicated by the reference sign B2, the task A is executed by hardware A. Once the task A enters an executable state, the task A transitions between the executable state and an executing state. The task A may also transition from the executing state to the executable state through a wait state and then transition between the executable state and the executing state again. Upon completion of the executing state, the task A transitions to a task A end state.

As indicated by the reference signs B3 and B4, the task B is processed by hardware B and the task C is processed by hardware C in substantially the same manner as the task A indicated by the reference sign B2.

In job scheduling performed by the job scheduler indicated by the reference sign B1, the hardware information, the site information, and the software information that is acquired via a compiler or runtime may be used.

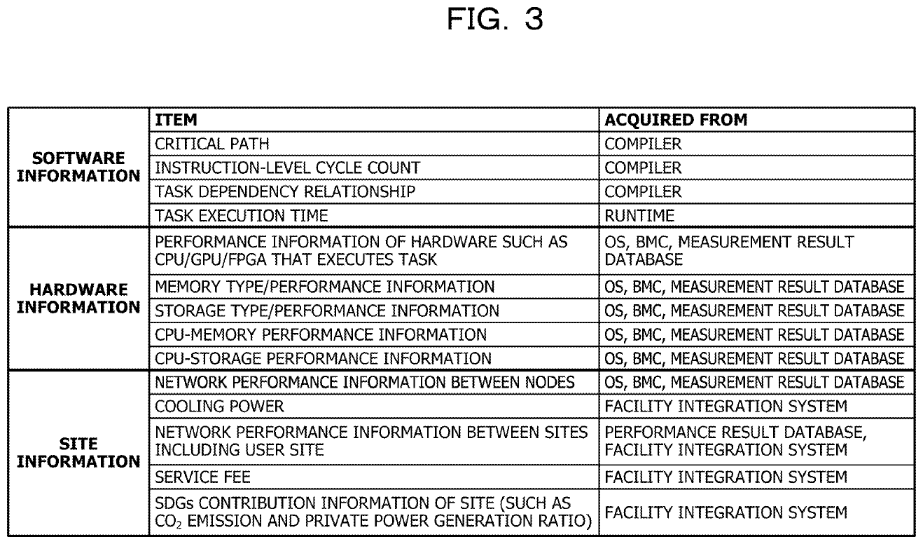

FIG. 3 is a table for describing an example of the software information, the hardware information, and the site information in the embodiment.

The software information may include a critical path, an instruction-level cycle count, a task dependency relationship, and a task execution time. The critical path, the instruction-level cycle count, and the task dependency relationship may be acquired from a compiler. The task execution time may be acquired from a runtime.

In acquisition of the software information, a dependency relationship between individual modules at the time of “make”, a relationship with a library to be used, and a dependency relationship between executed tasks may be taken into account.

As for the dependency relationship between individual modules at the time of “make”, for example, four source files “Source0.cpp”, “Source1.cpp”, “Source2.cpp”, and “Source3.cpp” are assumed to have dependency relationships of “Source0.cpp: Source1.cpp, Source2.cpp” and “Source1.cpp: Source2.cpp”. At this time, if “Source1.cpp” is rewritten, only “Source2.cpp” is to be recompiled and recompiling of “Source0.cpp” and “Source1.cpp” is unnecessary.

As for the relationship with a library to be used, software information that is optimum in a library used at the time of execution may be used.

As for the dependency relationship between executed tasks, each task may successively use a result of a previously executed task in some cases, and a dependency relationship such as the use of a file output by a previous task by a subsequent task may occur.

The hardware information may include performance information of hardware 10 such as a CPU/GPU/FPGA that executes a task, memory type/performance information, storage type/performance information, CPU-memory performance information, and CPU-storage performance information. The individual pieces of information included in the hardware information may be acquired from an operating system (OS), a baseboard management controller (BMC), or a measurement result database. “CPU” is an abbreviation for “central processing unit”, “GPU” is an abbreviation for “graphics processing unit”, and “FPGA” is an abbreviation for “field-programmable gate array”.

The site information may include network performance information between nodes, cooling power, network performance information between sites including a user site 5, a service fee, and Sustainable Development Goals (SDGs) contribution information of a site such as a CO₂ emission and a private power generation ratio. The network performance information between nodes may be acquired from the OS, the BMC, or the measurement result database. The cooling power, the service fee, and the SDGs contribution information of a site may be acquired from a facility integration system. The network performance information between sites may be acquired from a performance result database or the facility integration system.

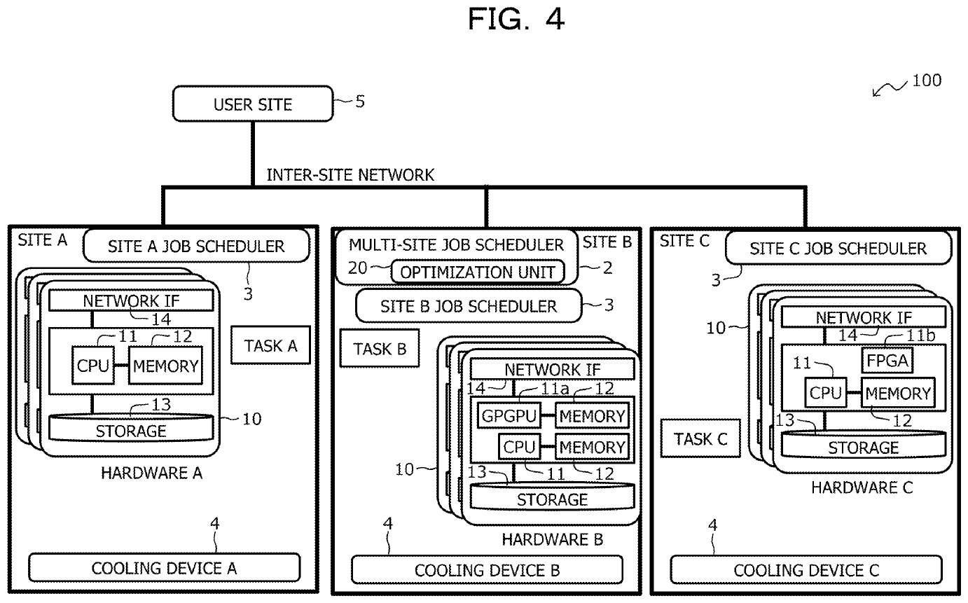

FIG. 4 is a block diagram schematically illustrating an example of a hardware configuration of an information processing system 100 according to the embodiment.

The information processing system 100 illustrated in FIG. 4 includes a plurality of sites A to C and the user site 5 that are coupled to each other via an inter-site network.

The user site 5 issues a job for executing arbitrary computation by using at least one of the sites A to C.

Each of the sites A to C is equipped with a plurality of pieces of hardware 10, a site job scheduler 3, and a cooling device 4, and executes a task. In the example illustrated in FIG. 4, the site A is equipped with the hardware A, a site A job scheduler, and a cooling device A and executes a task A. The site B is equipped with the hardware B, a site B job scheduler, and a cooling device B and executes a task B. The site C is equipped with the hardware C, a site C job scheduler, and a cooling device C and executes a task C.

In the example illustrated in FIG. 4, the site B is equipped with a multi-site job scheduler 2 (in other words, a control apparatus). The multi-site job scheduler 2 has a function of an optimization unit 20 for optimizing scheduling of tasks across a plurality of sites. The site A or the site B may be equipped with the multi-site job scheduler 2.

The optimization unit 20 acquires software information on a plurality of tasks included in a job, hardware information on the plurality of pieces of hardware 10, and site information on the plurality of sites. The optimization unit 20 determines which task of the job that has been input is to be allocated to which piece of hardware 10, by using a result of machine learning based on the software information, the hardware information, and the site information that have been acquired.

The site job scheduler 3 performs job scheduling in the corresponding site.

The cooling device 4 cools the plurality of pieces of hardware 10 in the corresponding site.

In the example illustrated in FIG. 4, the hardware A of the site A includes a CPU 11, a memory 12, a storage 13, and a network interface (IF) 14. The hardware B of the site B includes, in addition to the CPU 11 and the memory 12, general-purpose computing on graphics processing units (GPGPU) 11a and another memory 12 corresponding to the GPGPU 11a. Each of the pieces of hardware C of the site C includes, in addition to the CPU 11 and the memory 12, an FPGA 11b. For example, the pieces of hardware A to C of the sites A to C, respectively, may have different hardware configurations.

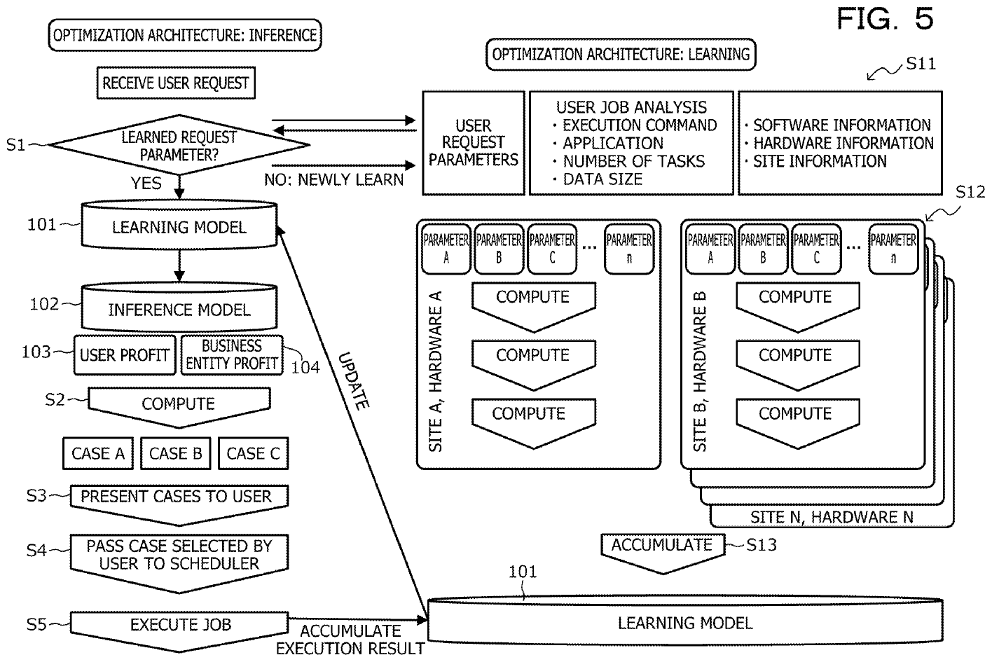

An optimization architecture of a job scheduling process in the embodiment will be described by using a flowchart (steps S1 to S5 and S11 to S13) illustrated in FIG. 5. Steps S1 to S5 indicate an optimization architecture for inference, and steps S11 to S13 indicate an optimization architecture for the machine learning.

In the optimization architecture for inference, in response to receipt of a user request, the optimization unit 20 determines whether the user request is related to a learned request parameter (step S1).

If the user request is not related to a learned request parameter (see a “No” route in step S1), the optimization unit 20 newly learns a user request parameter acquired by the optimization architecture for learning (step S1).

On the other hand, if the user request is related to a learned request parameter (see a “Yes” route in step S1), the optimization unit 20 refers to a learning model 101, an inference model 102, a user profit 103, and a business entity profit 104. Based on the information that is referred to, the optimization unit 20 computes a plurality of cases of job scheduling (step S2).

The optimization unit 20 presents the plurality of computed cases (cases A to C in the example illustrated in FIG. 5) of job scheduling to a user (step S3).

The optimization unit 20 passes a case selected by the user from among the plurality of presented cases, to the site job scheduler 3 at each site (step S4).

The optimization unit 20 causes the job to be executed at each site, and accumulates the execution result in the learning model 101 (step S5). The optimization architecture for inference then ends.

In the optimization architecture for learning, the optimization unit 20 acquires user request parameters, user job analysis information, software information, hardware information, and site information (step S11). The user job analysis information may include an execution command, an application, the number of tasks, and a data size.

The optimization unit 20 causes each piece of hardware 10 at each site to repeatedly perform the computation based on the plurality of parameters (step S12).

The optimization unit 20 accumulates the computation results obtained at the respective sites in the learning model 101 used in the optimization architecture for inference and updates the learning model 101 (step S13). The optimization architecture for learning then ends.

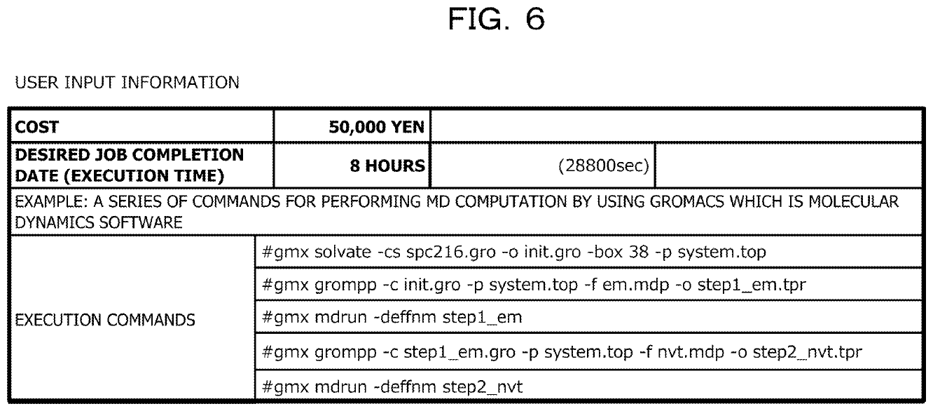

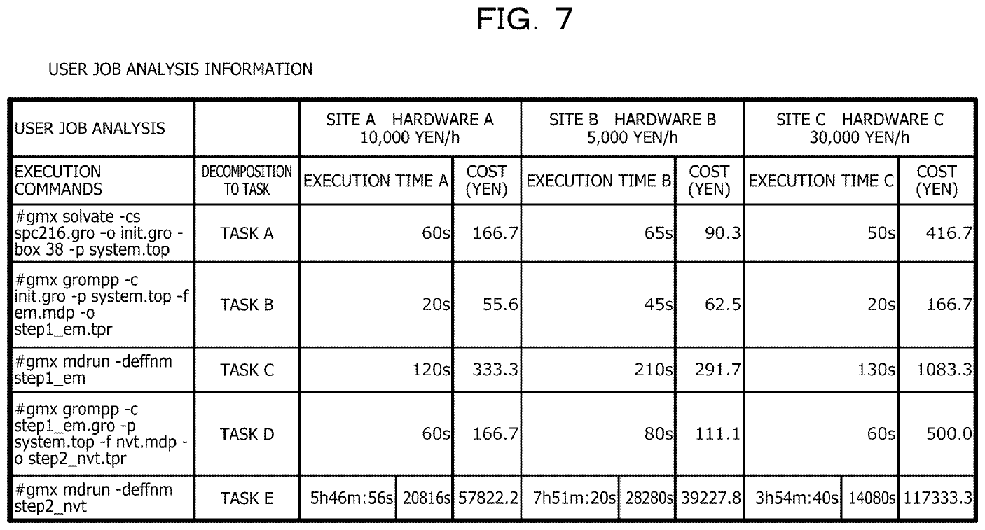

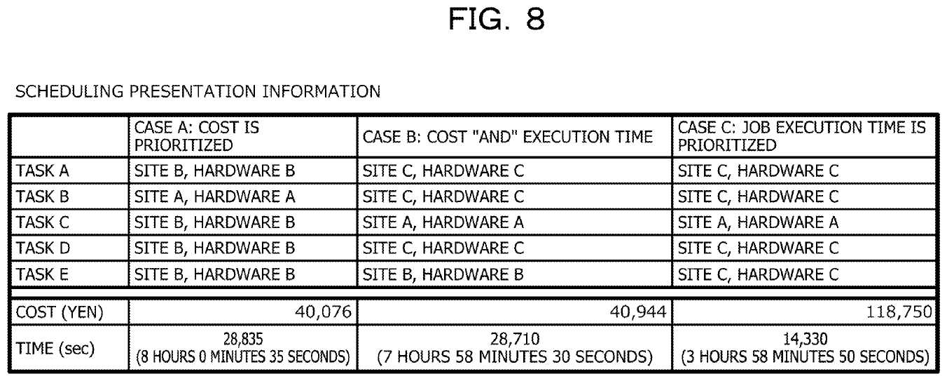

FIG. 6 is a table illustrating a first example of the user input information in the embodiment. FIG. 7 is a table illustrating a first example of the user job analysis information in the embodiment. FIG. 8 is a table illustrating a first example of the presented job scheduling information in the embodiment.

In the user input information illustrated in FIG. 6, 50,000 yen is input as a cost, 8 hours (28,800 sec) is input as a desired job completion date (in other words, the execution time), and a series of execution commands for performing molecular dynamics (MD) computation using GROMACS which is molecular dynamics software is input.

In the user job analysis information illustrated in FIG. 7, the execution commands are decomposed into a plurality of tasks A to E, and an execution time and a cost (yen) for each task are computed for each piece of hardware 10 at each site (for example, the hardware A at the site A, the hardware B at the site B, and the hardware C at the site C).

The presented job scheduling information illustrated in FIG. 8 indicates a total cost (yen) and a total time (sec) in a case where each of the tasks A to E is executed by each piece of hardware 10 at each of the sites.

In the example illustrated in FIG. 8, in a case A in which the cost is prioritized, the cost is 40,076 yen and the time is 28,835 sec (8 hours 0 minutes 35 seconds). In a case B corresponding to an “AND” condition of the cost and the execution time, the cost is 40,944 yen and the time is 28,710 sec (7 hours 58 minutes 30 seconds). In a case C in which the job execution time is prioritized, the cost is 118,750 yen and the time is 14,330 sec (3 hours 58 minutes 50 seconds).

The optimization unit 20 may present, as a first candidate, the case B in which both the cost and the time satisfy the user input information and present, as a second candidate, the case A in which the cost satisfies the user input information but the time slightly exceeds the user input information.

For example, the optimization unit 20 may present a combination of the allocations that satisfy at least one of a predetermined cost condition or a predetermined processing time condition.

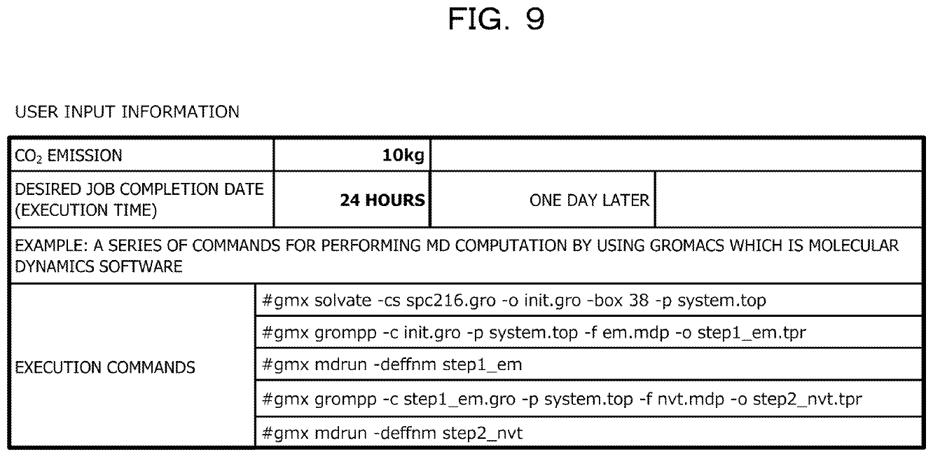

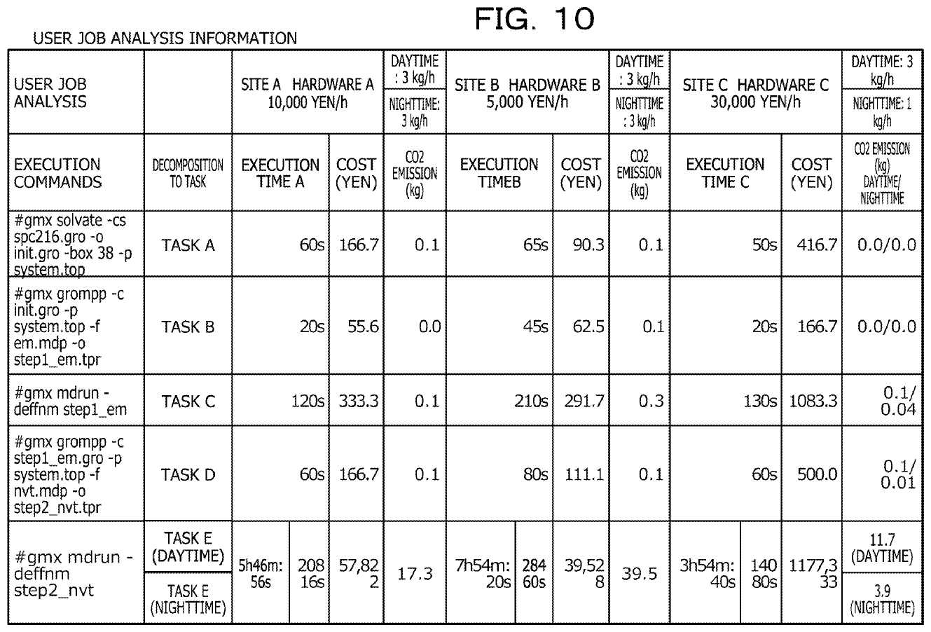

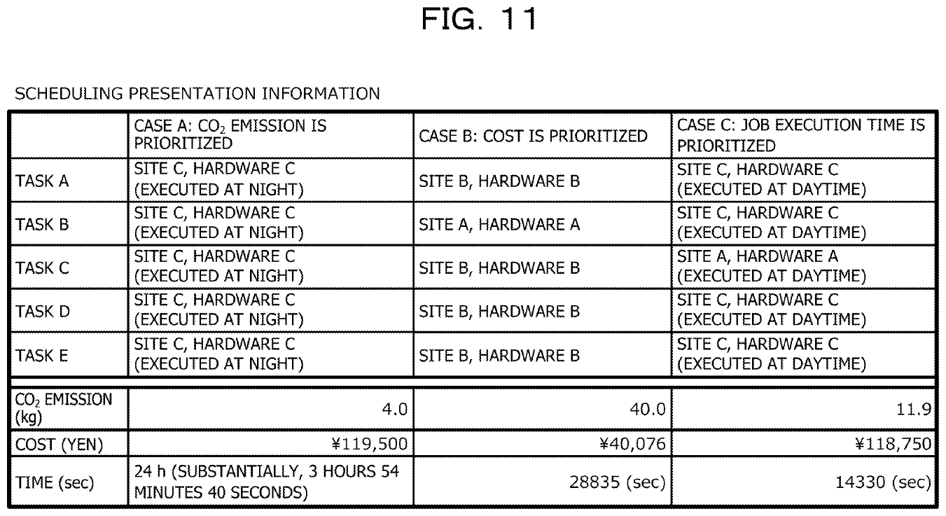

FIG. 9 is a table illustrating a second example of the user input information in the embodiment. FIG. 10 is a table illustrating a second example of the user job analysis information in the embodiment. FIG. 11 is a table illustrating a second example of the presented job scheduling information in the embodiment.

In the user input information illustrated in FIG. 9, 10 kg is input as the CO₂ emission, 24 hours is input as the desired job completion date (in other words, the execution time), and a series of execution commands for performing MD computation using GROMACS which is the molecular dynamics software is input.

In the user job analysis information illustrated in FIG. 10, the execution commands are decomposed into the plurality of tasks A to E, and an execution time and a cost (yen) for each task are computed for each piece of hardware 10 at each site (for example, the hardware A at the site A, the hardware B at the site B, and the hardware C at the site C).

In the example illustrated in FIG. 10, at the site C, since natural energy of sunlight and wind are used and power generated and charged at the daytime is usable at the nighttime, the amount of carbon dioxide generated at the nighttime is small. Thus, the optimization unit 20 may compute the CO₂ emission of each task separately for the daytime and the nighttime for the site C.

The presented job scheduling information illustrated in FIG. 11 indicates a total CO₂ emission (kg), a total cost (yen), and a total time (sec) in a case where each of the tasks A to E is executed by each piece of hardware 10 at each of the sites.

In the example illustrated in FIG. 11, in a case A in which the CO₂ emission is prioritized, the CO₂ emission is 4.0 kg, the cost is 119,500 yen, and the time is 24 hours (substantially 3 hours 54 minutes 40 seconds since execution of the job is waited until nighttime). In a case B in which the cost is prioritized, the CO₂ emission is 40.0 kg, the cost is 40,076 yen, and the time is 28,835 sec. In a case C in which the job execution time is prioritized, the CO₂ emission is 11.9 kg, the cost is 118,750 yen, and the time is 14,330 sec.

The optimization unit 20 may present, as a first candidate, the case A in which both the CO₂ emission and the time satisfy the user input information, and present, as a second candidate, the case C in which the time satisfies the user input information but the CO₂ emission slightly exceeds the user input information.

For example, the optimization unit 20 may present a combination of the allocations that satisfy a condition regarding an indicator related to environmental protection.

The optimization unit 20 may present a combination of the allocations such that the number of sites equipped with pieces of hardware to which the plurality of tasks are to be allocated is less than or equal to a threshold. The optimization unit 20 may present a combination of the allocations such that sites equipped with pieces of hardware to which the plurality of tasks are to be allocated are within a predetermined area (for example, within Japan or a specific country).

The optimization unit 20 may present a combination of the allocations such that the pieces of hardware 10 that have an identical configuration among the plurality of pieces of hardware 10 to which the plurality of tasks are to be allocated are used equally. As a selection method applied to the pieces of hardware 10 that have an identical configuration, various methods such as a round-robin method and a random method may be used.

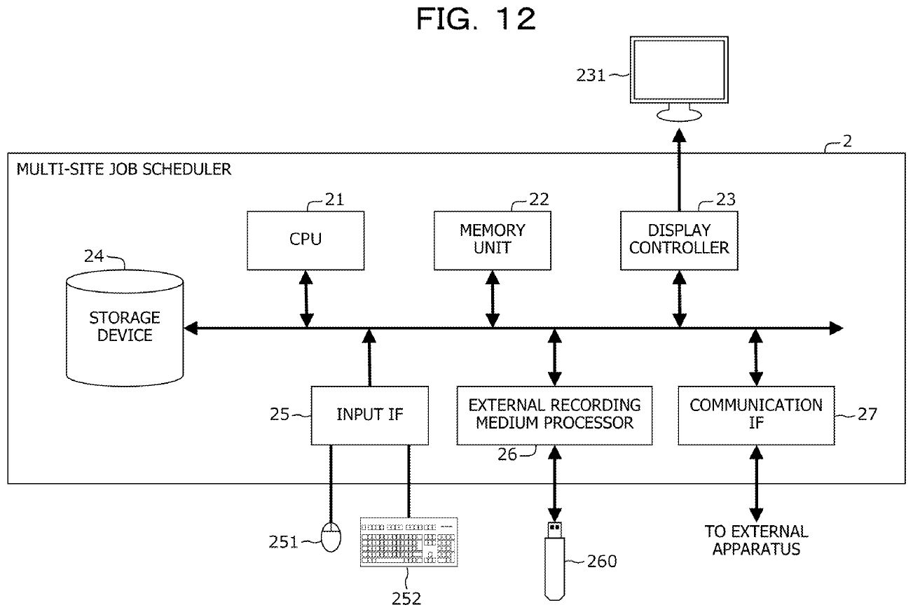

The presented job scheduling information illustrated in FIGS. 8 and 11 may be displayed on a display device 231 of the multi-site job scheduler 2 to be described later using FIG. 12 or a display device (not illustrated) of the user site 5 illustrated in FIG. 4.

Although Japanese yen is used as the unit of cost in FIGS. 6 to 11, various currency units such as US dollar and Euro may be used as the unit of cost. As the unit of the cost, a unit of legal currency in a country or area where the information processing system 100 is provided or a unit of virtual currency may be used.

FIG. 12 is a block diagram schematically illustrating an example of a hardware configuration of the multi-site job scheduler 2 in the embodiment.

The multi-site job scheduler 2 illustrated in FIG. 4 includes a CPU 21, a memory unit 22, a display controller 23, a storage device 24, an input IF 25, an external recording medium processor 26, and a communication IF 27.

The memory unit 22 is an example of a storage and includes, for example, a read-only memory (ROM), a random-access memory (RAM), and so forth. Programs such as a Basic Input/Output System (BIOS) may be written in the ROM of the memory unit 22. Software programs in the memory unit 22 may be appropriately loaded and executed by the CPU 21. The RAM of the memory unit 22 may be used as a memory for temporary recording or as a working memory.

The display controller 23 is coupled to the display device 231 and controls the display device 231. The display device 231 is a liquid crystal display, an organic light-emitting diode (OLED) display, a cathode ray tube (CRT) display, an electronic paper display, or the like and displays various kinds of information to an operator or the like. The display device 231 may be combined with an input device. For example, the display device 231 may be a touch panel.

The storage device 24 is a storage device with high IO performance. For example, a dynamic random-access memory (DRAM), a solid-state drive (SSD), a storage class memory (SCM), or a hard disk drive (HDD) may be used as the storage device 24.

The input IF 25 may be coupled to input devices such as a mouse 251 and a keyboard 252 and control the input devices such as the mouse 251 and the keyboard 252. The mouse 251 and the keyboard 252 are an example of the input devices. The operator performs various input operations via these input devices.

The external recording medium processor 26 is configured so that a recording medium 260 may be mounted thereto. The external recording medium processor 26 is configured to be able to read information recorded on the recording medium 260 in a state in which the recording medium 260 is mounted to the external recording medium processor 26. In this example, the recording medium 260 is portable. For example, the recording medium 260 is a flexible disk, an optical disc, a magnetic disk, a magneto-optical disk, a semiconductor memory, or the like.

The communication IF 27 is an interface that enables communication with an external apparatus.

The CPU 21 is an example of a processor, and is a processing device that performs various controls and computations. By executing the OS and the programs loaded to the memory unit 22, the CPU 21 implements various functions. The CPU 21 functions as the optimization unit 20 described by using FIG. 4.

A device for controlling the entire operations of the multi-site job scheduler 2 is not limited to the CPU 21 and may be any one of an MPU, a DSP, an ASIC, a PLD, and an FPGA. The device for controlling the entire operations of the multi-site job scheduler 2 may be a combination of two or more of a CPU, an MPU, a DSP, an ASIC, a PLD, and an FPGA. “MPU” is an abbreviation for “microprocessor unit”. “DSP” is an abbreviation for “digital signal processor”. “ASIC” is an abbreviation for “application-specific integrated circuit”. “PLD” is an abbreviation for “programmable logic device”.

### [B] Effects

The control program, the control apparatus, and the control method according to the embodiment described above may provide the following operation effects, for example.

The optimization unit 20 acquires the software information on a plurality of tasks included in a job, the hardware information on the plurality of pieces of hardware 10, and the site information on the plurality of sites. The optimization unit 20 determines which task of the job that has been input is to be allocated to which piece of hardware 10, by using a result of learning based on the software information, the hardware information, and the site information that have been acquired.

Thus, it is possible to provide optimum job scheduling in consideration of an environment that varies from site to site. For example, it is possible to provide a job scheduler that plans and executes a job while satisfying a user request, by learning the software information, the hardware information, and the site information of supercomputers located across multiple sites. For example, since the multiple sites may be used for execution of a job, the efficiency of the execution of the job increases.

The optimization unit 20 presents a combination of the allocations that satisfy at least one of a predetermined cost condition or a predetermined processing time condition. This allows a user to make a selection that satisfies a user request regarding the cost, the execution time, or the like.

The optimization unit 20 presents a combination of the allocations that satisfy a condition regarding an indicator related to environmental protection. This allows the user to make a selection that satisfies a user request regrading a CO₂ emission or the like and thus to contribute to SDGs efforts or the like.

The optimization unit 20 presents a combination of the allocations such that the number of sites equipped with pieces of hardware to which the plurality of tasks are to be allocated is less than or equal to a threshold. This allows the user to limit the number of times of data movement between sites related to execution of a job and thus to reduce the data leakage risk or the like.

The optimization unit 20 presents a combination of the allocations such that sites equipped with pieces of hardware to which the plurality of tasks are to be allocated are within a predetermined area. This allows the user to limit data movement related to execution of a job within a country or the like and thus to reduce the data leakage risk or the like.

The optimization unit 20 presents a combination of the allocations such that the pieces of hardware 10 that have an identical configuration among the plurality of pieces of hardware 10 to which the plurality of tasks are to be allocated are used equally. This allows a business entity that provides the system to avoid concentration of loads on a specific site or a specific piece of hardware 10 and thus to effectively use computer resources across multiple sites.

### [C] Others

The disclosed technique is not limited to the embodiment described above, and may be carried out by variously modifying the technique within a range not departing from the gist of the present embodiment. Each of the configurations and each of the processes of the present embodiment may be selectively employed or omitted as desired or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a control program for causing a computer configured to execute scheduling of a job across a plurality of pieces of hardware deployed at a plurality of sites to execute a process comprising:
acquiring software information on a plurality of tasks included in the job, hardware information on the plurality of pieces of hardware, and site information on the plurality of sites; and
determining which task of the job that has been input is to be allocated to which piece of hardware by using a result of machine learning based on the software information, the hardware information, and the site information that have been acquired.

2. The non-transitory computer-readable recording medium according to claim 1, the process further comprising:
presenting a combination of the allocations that satisfy at least one of a predetermined cost condition or a predetermined processing time condition.

3. The non-transitory computer-readable recording medium according to claim 1, the process further comprising:
presenting a combination of the allocations that satisfy a condition regarding an indicator related to environmental protection.

4. The non-transitory computer-readable recording medium according to claim 1, the process further comprising:
presenting a combination of the allocations such that the number of sites equipped with pieces of hardware to which the plurality of tasks are to be allocated is less than or equal to a threshold.

5. The non-transitory computer-readable recording medium according to claim 1, the process further comprising:
presenting a combination of the allocations such that sites equipped with pieces of hardware to which the plurality of tasks are to be allocated are within a predetermined area.

6. The non-transitory computer-readable recording medium according to claim 1, the process further comprising:
presenting a combination of the allocations such that pieces of hardware that have an identical configuration among the plurality of pieces of hardware to which the plurality of tasks are to be allocated are used equally.

7. A control apparatus for scheduling of a job across a plurality of pieces of hardware deployed at a plurality of sites to execute a process comprising:
a memory, and
a processor coupled to the memory and configured to:
acquire software information on a plurality of tasks included in the job, hardware information on the plurality of pieces of hardware, and site information on the plurality of sites; and
determine which task of the job that has been input is to be allocated to which piece of hardware by using a result of machine learning based on the software information, the hardware information, and the site information that have been acquired.

8. The control apparatus according to claim 7, the processor is further configured to:
present a combination of the allocations that satisfy at least one of a predetermined cost condition or a predetermined processing time condition.

9. The control apparatus according to claim 7, the processor is further configured to:
present a combination of the allocations that satisfy a condition regarding an indicator related to environmental protection.

10. The control apparatus according to claim 7, the processor is further configured to:
present a combination of the allocations such that the number of sites equipped with pieces of hardware to which the plurality of tasks are to be allocated is less than or equal to a threshold.

11. The control apparatus according to claim 7, the processor is further configured to:
present a combination of the allocations such that sites equipped with pieces of hardware to which the plurality of tasks are to be allocated are within a predetermined area.

12. The control apparatus according to claim 7, the processor is further configured to:
present a combination of the allocations such that pieces of hardware that have an identical configuration among the plurality of pieces of hardware to which the plurality of tasks are to be allocated are used equally.

13. A control method for causing a computer configured to execute scheduling of a job across a plurality of pieces of hardware deployed at a plurality of sites to execute a process comprising:
acquiring software information on a plurality of tasks included in the job, hardware information on the plurality of pieces of hardware, and site information on the plurality of sites; and
determining which task of the job that has been input is to be allocated to which piece of hardware by using a result of machine learning based on the software information, the hardware information, and the site information that have been acquired.

14. The control method according to claim 13, the process further comprising:
presenting a combination of the allocations that satisfy at least one of a predetermined cost condition or a predetermined processing time condition.

15. The control method according to claim 13, the process further comprising:
presenting a combination of the allocations that satisfy a condition regarding an indicator related to environmental protection.

16. The control method according to claim 13, the process further comprising:
presenting a combination of the allocations such that the number of sites equipped with pieces of hardware to which the plurality of tasks are to be allocated is less than or equal to a threshold.

17. The control method according to claim 13, the process further comprising:
presenting a combination of the allocations such that sites equipped with pieces of hardware to which the plurality of tasks are to be allocated are within a predetermined area.

18. The control method according to claim 13, the process further comprising:
presenting a combination of the allocations such that pieces of hardware that have an identical configuration among the plurality of pieces of hardware to which the plurality of tasks are to be allocated are used equally.
